(19) United States
(12) Patent Application Publication
(10) Pub. No.: US 2024/0415324 A1
(43) Pub. Date: Dec. 19, 2024

(54) Milk Beverage Heating Stirrer

(71) Applicant: Xingjian XIONG, Shenzhen (CN)

(72) Inventor: Xingjian XIONG, Shenzhen (CN)

(21) Appl. No.: 18/814,588

(22) Filed: Aug. 26, 2024

Related U.S. Application Data
(63) Continuation of application No. PCT/CN2023/130267, filed on Nov. 7, 2023.

(30) Foreign Application Priority Data
Nov. 16, 2022 (CN) 202223052771.4

(51) Int. Cl. A47J 36/24; A47J 36/16; A47J 43/046

(52) U.S. Cl. CPC A47J 36/2444; A47J 36/165; A47J 43/046

(57) ABSTRACT

A milk beverage heating stirrer comprises a cup (100), a base (200), a heating device (300), a heat conduction liquid (10), a stirrer (400), a driving device (700) and an electric control device (500). The cup (100) is configured to contain a milk beverage. The heating device (300) comprises a heating container (310) and a heating assembly (320). The heat conduction liquid (10) is added into the heating container (310). The cup (100) is detachably positioned in the heating container (310). The heating device (300) is configured to heat the heat conduction liquid (10). The heating device (300) and the heat conduction liquid (10) can heat and conduct heat to a cup bottom wall (170) and a cup lower side wall (180) of the cup (100) simultaneously.

This is a continuation application of PCT international application number PCT/CN2023/130267, filing date Nov. 7, 2023, which claimed priority to Chinese Patent Application No. 202223052771.4, entitled “Milk Beverage Heating Stirrer”, filed with the China National Intellectual Property Administration on Nov. 16, 2022. The contents of these specifications, including any intervening amendments thereto, are incorporated herein by reference. in its entirety.

### BACKGROUND OF THE PRESENT INVENTION

The application relates to the technical field of liquid food processing equipment, in particular to, for example, a milk beverage heating stirrer.

### DESCRIPTION OF RELATED ARTS

A milk beverage heating stirrer, as an appliance for heating and stirring milk or other beverages, generally can heat milk or other beverages in a cup to a temperature of about 60° C.-70° C., and a stirrer can be driven by the magnetic force of a magnetic disk on a motor to rotate to stir the heated milk to froth it into hot milk foam. Or, the stirrer can stir the milk or other beverages at normal temperature as required, that is, the stirrer can stir and froth the milk into cold milk foam.

In related art, some split-type milk beverage heating stirrers use a flat aluminum heating plate as a heating device, the flat aluminum heating plate is in contact with an aluminum heat-conduction plate welded to an outer bottom surface of a cup to heat the aluminum heat-conduction plate to further heat a milk beverage in the cup. However, because the flat aluminum heating plate is in contact with the aluminum heat-conduction plate welded to the outer bottom surface of the cup to realize contact heat conduction and heating, the heat conduction area of the aluminum heat-conduction plate on the outer bottom surface of the cup is limited and small, and heat conduction is unsmooth. Moreover, a quick rise of the local temperature of the heating plate will lead to frequent tripping of a temperature control device for detecting the temperature of the heating plate, so heating needs to be paused and will not resume until the local temperature falls, and the heating process is intermittent, resulting in a long heating and heat conduction time, low heating efficiency and a long milk heating time as fed back by customers; in addition, the aluminum heat-conduction plate welded to the outer bottom surface of the cup has a complex subsequent machining process and a high machining cost.

### SUMMARY OF THE PRESENT INVENTION

The application provides a milk beverage heating stirrer, comprising:
a cup, the cup being configured to contain a milk beverage;
a base;
a heating device, the heating device comprising a heating container and a heating assembly, the heating assembly being arranged outside the heating container, the heating device being mounted on the base, the heating container being formed by a container bottom wall, a container side wall and an abutting portion, an opening beingformed in an upper end of the heating container, an upper end of the container side wall extending outwards to form the abutting portion, and the abutting portion abutting against an upper end of a shell of the base; and
a heat conduction liquid, the heat conduction liquid being added into the heating container, and the heating device being configured to heat the heat conduction liquid;
wherein, the cup is detachably positioned in the heating container, the heating device and the heat conduction liquid are configured to heat and conduct heat to a cup bottom wall and a cup lower side wall of the cup simultaneously;
the milk beverage heating stirrer adopts one of the following configurations:
the cup comprises a first receiving portion and a second receiving portion connected with the first receiving portion, the first receiving portion is located above the second receiving portion, a diameter of the first receiving portion is greater than that of the second receiving portion, a support shoulder is formed at a joint of the first receiving portion and the second receiving portion, and in a case where the cup is placed in the heating container, the support shoulder abuts against a container upper end surface of the heating container and is configured to be movably positioned on the heating container;
an upper portion of the container side wall inclines outwards to form a circular container positioning portion, a diameter of an upper end of the container positioning portion is greater than that of a lower end of the container positioning portion, the cup bottom wall of the cup abuts against the container bottom wall of the heating container, and a portion of an outer side wall of the cup abuts against and is positioned on the container positioning portion.

As a scheme of the milk beverage heating stirrer provided by the application, the heating container further comprises a container lid, the container lid comprises a circular upper lid portion and a circular wall, a through-hole is defined by the circular upper lid portion and the circular wall, a diameter of an upper end of the through-hole is greater than that of a lower end of the through-hole, the container lid is detachably arranged at the opening of the container, the circular upper lid portion abuts against the container upper end surface of the heating container, the circular wall is positioned on an inner wall of an upper portion of the heating container, and a portion of the outer side wall of the cup is detachably positioned on an inner wall positioning portion of the through-hole.

As a scheme of the milk beverage heating stirrer provided by the application, a positioning flange structure is arranged on a bottom inner side of the heating container.

As a scheme of the milk beverage heating stirrer provided by the application, a hydrophobic coating material is arranged on an outer surface of the cup.

As a scheme of the milk beverage heating stirrer provided by the application, a positioning shaft is fixedly arranged at a center of an inner bottom surface of the cup, a stirrer is detachably and rotatably mounted on the positioning shaft, and a driven magnet is arranged in the stirrer.

As a scheme of the milk beverage heating stirrer provided by the application, a driving device is arranged in the base and comprises a motor and a magnetic driving disk fixedly connected to an output shaft of the motor, a driving magnet is fixedly arranged on the magnetic driving disk, and the driving device is configured to magnetically drive the stirrer to rotate by means of the magnetic driving disk.

As a scheme of the milk beverage heating stirrer provided by the application, the milk beverage heating stirrer further comprises an electric control device, a temperature controller and a switching device, wherein the heating device, the driving device, the temperature controller and the switching device are all electrically connected to the electric control device, and the electric control device is configured to control the heating device and the driving device to start or stop.

As a scheme of the milk beverage heating stirrer provided by the application, the stirrer is not placed in the cup, a preset amount of drinking water is added into the cup according to scale, the cup is covered with a cup lid, the heat conduction liquid is added into the heating container, and in a case where the cup containing the drinking water is placed in the heating container, a water boiling function of the switching device is enabled, and the milk beverage heating stirrer functions as a kettle.

### BRIEF DESCRIPTION OF THE DRAWINGS

FIG. 1 is an external view of a milk beverage heating stirrer according to Embodiment 1 of the application;

FIG. 2a is an internal structural view of the milk beverage heating stirrer according to Embodiment 1 of the application;

FIG. 2b is a structural view of a heating container and a heating assembly according to Embodiment 1 of the application;

FIG. 2c is an exploded view of the milk beverage heating stirrer according to Embodiment 1 of the application;

FIG. 3a is an internal structural view of a milk beverage heating stirrer according to Embodiment 2 of the application;

FIG. 3b is a structural view of a heating container and a heating assembly according to Embodiment 2 of the application;

FIG. 3c is an exploded view of the milk beverage heating stirrer according to Embodiment 2 of the application;

FIG. 4a is an internal structural view of a milk beverage heating stirrer according to Embodiment 3 of the application;

FIG. 4b is an exploded view of the milk beverage heating stirrer according to Embodiment 3 of the application;

FIG. 4c is a top view of a heating container according to Embodiment 3 of the application;

FIG. 4d is a structural view of the milk beverage heating stirrer functioning as a kettle according to Embodiment 3 of the application.

In the FIGS.:
10, heat conduction liquid;
100, cup; 110, first receiving portion; 120, second receiving portion; 130, support shoulder; 140, cup spout; 150, cup lid; 160, handle; 170, cup bottom wall; 180, cup lower side wall; 190, drinking water;
200, base; 210, shell;
300, heating device; 310, heating container; 311, container bottom wall; 312, container side wall; 3121, container positioning portion; 313, abutting portion; 314, container spout; 315, container upper end surface; 316, positioning flange structure; 320, heating assembly; 321, heating component; 322, heat conduction component; 323, temperature controller; 330, container lid; 331, circular upper lid portion; 332, circular wall; 333, through-hole; 334, inner wall positioning portion; 335, silicone ring;
400, stirrer; 410, driven magnet; 420, positioning shaft;
500, electric control device; 510, wire;
600, switching device;
700, driving device; 710, motor; 720, magnetic driving disk; 730, driving magnet.

### DETAILED DESCRIPTION OF THE PREFERRED EMBODIMENT

The application is described below in conjunction with accompanying drawings and embodiments. The specific embodiments described here are merely used for explaining the application. For the sake of a brief description, only parts related to the application are shown in the accompanying drawings.

In the description of the application, unless otherwise stated and defined, terms “join”, “connect” and “fix” should be broadly understood. For example, “connect” may refer to fixed connection, detachable connection or integrated connection; or, mechanical connection or electrical connection; or, direct connection, indirect connection by means of an intermediate medium, or internal connection or interaction between two elements. Those ordinarily skilled in the art can appreciate the meanings of these terms in the application as the case may be.

In the application, unless otherwise stated and defined, if a first feature is located “over” or “under” a second feature, it indicates that the first feature and the second feature are in direct contact, or it indicates that the first feature and the second feature are in contact by means of another feature there between rather than being in direct contact. In addition, if a first feature is located “over”, “above” or “on” a second feature, it indicates that the first feature is located exactly or obliquely above the second feature, or it only indicates that the first feature is higher than the second feature. If a first feature is located “under”, “below” or “underneath” a second feature, it indicates that the first feature is located exactly or obliquely below the second feature, or it only indicates that the first feature is lower than the second feature.

In the description of the embodiments of the application, terms “upper”, “lower”, “right” and “left” are used to indicate directional or positional relationships based on the accompanying drawings merely for the purpose of facilitating and simplifying operations, do not indicate or imply that devices or elements referred to must be in a specific direction or be configured and operated in a specific direction, and thus should not be construed as limitations of the application. In addition, terms “first” and “second” are merely used for distinguishing similar objects in description and do not have any special meaning.

The embodiments of the application are described in detail below, and examples of the embodiments are shown in the accompanying drawings, in which identical or similar reference signs indicate identical or similar elements or elements with identical or similar functions. The embodiments described below with reference to the accompanying drawings are illustrative and only used for explaining the application, and should not be construed as limitations of the application.

### Embodiment 1

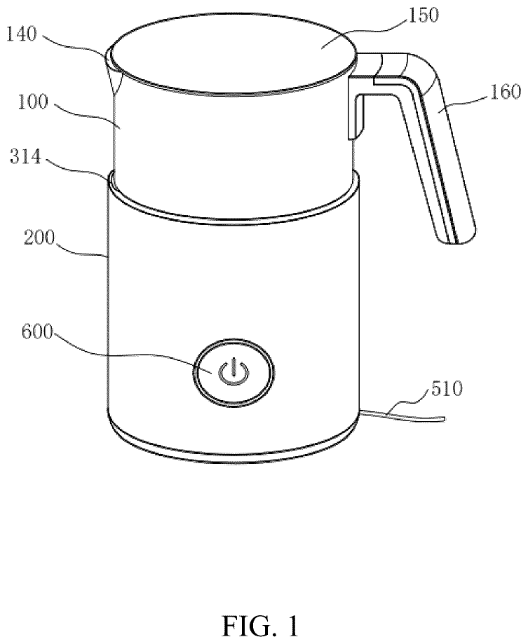

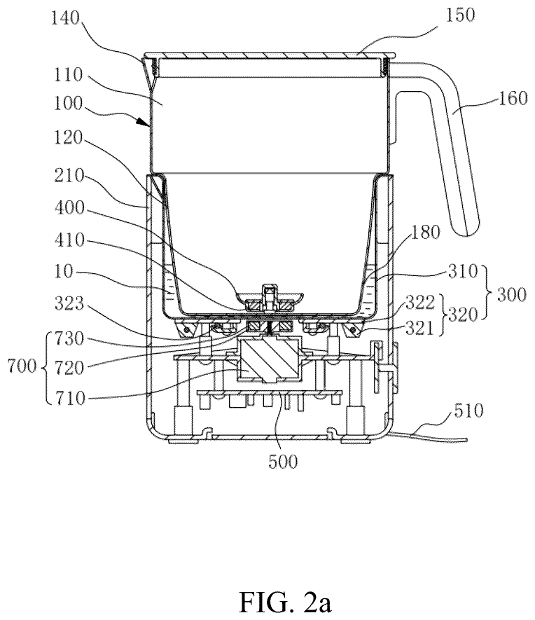

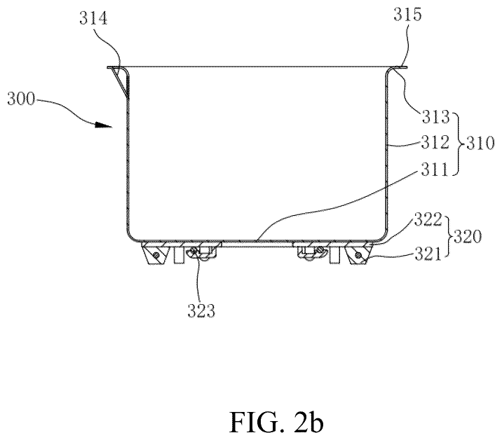

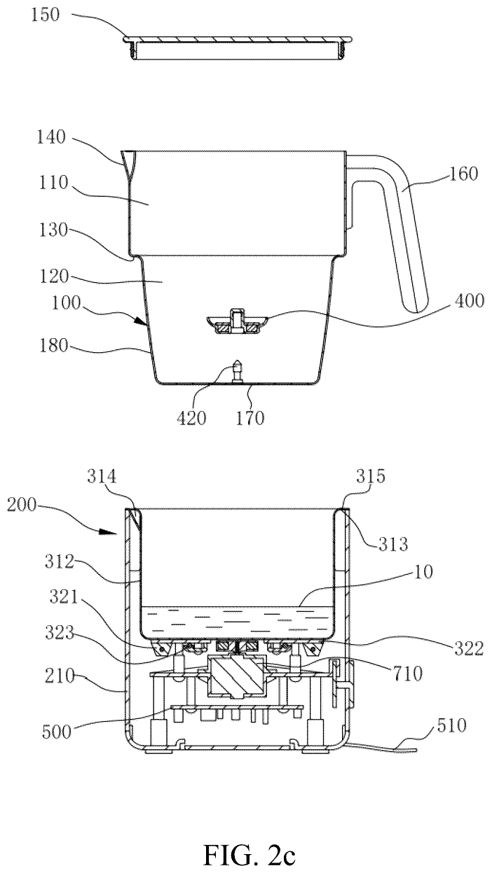

As shown in FIGS. 1, 2a, 2b and 2c, this embodiment provides a milk beverage heating stirrer, comprising a cup 100, a base 200, a heating device 300, a heat conduction liquid 10, a stirrer 400, a driving device 700, an electric control device 500 and a switching device 600.

The base 200 comprises a shell 210, and the heating device 300 abuts against and is mounted on the shell 210 of the base 200.

The heating device 300 comprises a heating container 310 and a heating assembly 320, wherein the heating container 310 is formed by a container bottom wall 311, a container side wall 312 and an abutting portion 313, an upper end of the container side wall extends outwards to form the abutting portion 313, the abutting portion 313 abuts against and is mounted at an upper end of the shell 210 of the base 200, an opening is formed in an upper end of the heating container 310, and the heating container 310 is further provided with a container spout 314 configured to discharge hot steam generated when the heat conduction liquid 10 is heated.

The heating assembly 320 is welded and fixed to an outer bottom wall of the heating container 310 and comprises a heating component 321 and a heat conduction component 322, the heating component 321 may be an electric heating tube, the heat conduction component 322 may be an aluminum plate, a through-hole is formed in the middle of the aluminum plate, the electric heating tube used as the heating component 321 and the aluminum plate used as the heat conduction component 322 are combined and soldered to be fixed to an outer bottom of the heating container 310, and stud nuts are riveted to the aluminum plate used as the heat conduction component 322 and configured to mount a temperature controller 323.

The heating assembly 320 may be other heating units such as a mica heating device, which may be arranged on an outer side wall or an outer bottom wall of the heating container 310.

The heating container 310 is made from steel use stainless 304 (SUS304) or SUS316 by drawing, and may also be made from other materials.

As shown in FIGS. 2a and 2b, the temperature controller 323 may be a negative temperature coefficient (NTC) thermistor and mounted on the aluminum plate used as the heat conduction component 322 at the outer bottom of the heating container 310 to detect the heating temperature of the heat conduction liquid 10 in the heating container 310 and milk in the cup 100. In this embodiment, the heating device 300 heats the heat conduction liquid 10, and heat conduction liquid 10 conducts heat to a cup bottom wall 170 and a cup lower side wall 180 of the cup 100 simultaneously to indirectly heat the milk in the cup 100. The temperature of the heat conduction liquid 10 is the same as the temperature of the milk in the cup 100. When the temperature of the milk in the cup 100 reaches a set temperature which is generally 60° C.-70° C., the temperature controller 323 transmits a temperature signal to the electric control device 500, and the electric control device 500 controls the heating component 321 to stop heating. The temperature controller 323 may be replaced with other temperature control devices and mounted on an outer side wall of the heating container 310. A snap-action temperature control device, such as a KSD301 snap-action temperature control device, may be mounted on the electric heating tube used as the heating component 321 to control the temperature of the electric heating tube.

As shown in FIG. 2a, an appropriate amount of the heat conduction liquid 10 is added to the heating container 310 according to the scale, and the heat conduction liquid may be drinking water or other drinkable liquids with a good heat conduction effect. The cup lower side wall 180 is immersed in the heat conduction liquid 10 by a certain height, and the quantity of the heat conduction liquid 10 added into the heating container should ensure that the heat conduction liquid 10 will not overflow from the heating container 310, the heat conduction effect on the milk in the cup 100 can be improved and the heating time can be shortened. Generally, the circumferential heat conduction area of the cup lower side wall 180 is about 1-2 times of the heat conduction area of the cup bottom wall 170. The heat conduction liquid 10 is used for conducting heat to the cup bottom wall and the cup lower side wall 180 of the cup 100 simultaneously during the heating process to improve the heating efficiency of the milk in the cup 100 and shorten the milk heating time.

In related art, the flat aluminum heating plate is in direct contact with the aluminum heat-conduction plate welded to the outer bottom surface of the cup to realize heat conduction and heating, and the heat conduction area of the bottom surface of the cup is small, so heat conduction is unsmooth, the local temperature of the heating plate rises quickly, the temperature control device for detecting the temperature of the heating plate trips frequently, heating needs to be paused and will not resume until the local temperature falls, and the heating process is intermittent, resulting in a long heating time. In this embodiment, an appropriate amount of the heat conduction liquid 10 is added into the heating container 310, and the heat conduction liquid 10 can uniformly conduct heat to the cup bottom wall 170 and the cup lower side wall 180 simultaneously, such that the heat conduction area is enlarged, heat conduction is smooth, heating is continuous, and the milk heating rate is higher.

Referring to FIGS. 2a and 2b, the cup 100 is formed by a first receiving portion 110, a second receiving portion 120 connected with the first receiving portion 110, and the cup bottom wall 170, wherein the first receiving portion 110 is located above the second receiving portion 120, the diameter of the first receiving portion 110 is greater than that of the second receiving portion 120, and a support shoulder 130 is formed at a joint of the first receiving portion 110 and the second receiving portion 120. When the cup 100 is placed in the heating container 310, the support shoulder 130 abuts against a container upper end surface 315, such that the cup 100 and the heating container 310 are positioned in a direction perpendicular to the axial direction; and an outer side wall of the second receiving portion 120 of the cup 100 is configured to be in small clearance fit with in the opening in the upper end of the heating container 310 in the diameter direction.

As shown in FIGS. 2a and 2b, an appropriate clearance is reserved between the cup bottom wall 170 of the cup 100 and the container bottom wall 311 of the heating container 310, and a portion of the heat conduction liquid 10 can be received in the clearance. When the heating device 300 performs heating, the heat conduction liquid 10 can heat or conduct heat to the cup bottom wall 170 and the cup lower side wall 180 of the cup 100 simultaneously to improve the heating efficiency of the milk in the cup 100.

A positioning shaft 420 is fixedly arranged at the center of an inner bottom surface of the cup 100, and the stirrer 400 is movably mounted on the positioning shaft 420; a handle 160 is fixedly connected to an outer side of an upper portion of the cup 100 to allow users to take and place the cup 100; moreover, a cup spout 140 is arranged on the cup 100 to pour the milk out of the cup 100 and discharge hot steam generated when the milk is heated out of the cup 100.

An opening in an upper end of the cup 100 is covered with a cup lid 150, and an elastic ring is arranged on the cup lid 150 and made from food-grade silicone.

The cup 100 is made from SUS304 or SUS316 by drawing, and may also be made from other materials such as a glass cup made from high-temperature high-boron glass.

The driving device 700 is arranged in the base 200 and comprises a motor 710 and a magnetic driving disk 720 fixedly connected to an output shaft of the motor 710, and a driving magnet 730 is fixedly arranged on the magnetic driving disk 720. Wherein, a driven magnet 410 in the stirrer 400 and the driving magnet 730 are aligned in the axial direction for magnetic attraction. Under the action of mutual magnetic attraction between the driving magnet 730 on the magnetic driving disk 720 and the driven magnet 410 in the stirrer 400, the magnetic driving disk 720 of the driving device 700 can magnetically drive the stirrer 400 in the cup 100 to rotate to stir and froth the milk in the cup 100.

The milk beverage heating stirrer further comprises the electric control device and the switching device 600. The electric control device 500 is arranged below the heating container 310, and the switching device 600 is arranged on the shell 210. Wherein, the heating component 321, the driving device 700, the temperature controller 323 and the switching device 600 are electrically connected to the electric control device 500, and the electric control device 500 controls the heating component 321 and the driving device 700 to start or stop. In this embodiment, the electric control device 500 is a main control printed circuit board (PCB) and connected to a power supply assembly such as a household receptacle by means of a wire 510 and a plug arranged on a lower portion of the base 200.

The stirrer 400 is detachably and rotatably mounted on the positioning shaft 420, the driven magnet 410 is arranged in the stirrer 400, and the stirrer 400 is configured to stir the liquid milk in the cup 100 so as to froth the milk.

The operating process of the milk beverage heating stirrer is as follows: the stirrer is movably mounted on the positioning shaft 420 on the inner bottom surface of the cup 100, an appropriate amount of milk is added into the cup 100 according to the scale, the cup lid 150 is closed, an appropriate amount of drinking water is added into the heating container 310 of the heating device 300 to function as the heat conduction liquid 10, the cup 100 containing the milk is placed and mounted in the heating container 310, the switching device 600 is started, the driving device 700 magnetically drives the stirrer 400 to rotate to stir the milk, and at the same time, the heating device 300 and the heat conduction liquid 10 heats and conducts heat to the cup bottom wall 170 and the cup lower side wall 180 of the cup 100 simultaneously; when the temperature of the milk in the cup reaches a set temperature range, the electric control device 500 controls the heating component 321 to stop heating and controls the driving device 700 to stop stirring, such that the milk in the cup 100 is heated and stirred to be frothed.

A hydrophobic coating material is arranged on an outer surface of the cup 100. Wherein, the outer surface comprises an outer side surface of a cup 100 side wall and an outer bottom surface of the cup bottom wall 170. The high-temperature wear-resistant hydrophobic coating material is arranged on the outer side surface of the cup side wall and the outer bottom surface of the cup bottom wall 170 of the cup 100, such that when the cup is taken out from the heating container 310 containing the heat conduction liquid 10, no water will drop from the outside of the cup 100 onto a table or desk. The application has no limitation to the hydrophobic coating material, the hydrophobic coating material may be a high-temperature wear-resistant hydrophobic coating made from polytetrafluoroethylene (PTFE) or ceramic, and generally, a colorless and transparent hydrophobic coating material is used. The hydrophobic coating material may be firmly adhered to the outer surface of the cup 100 in various ways, such as by spraying, dip coating, or the like.

According to the milk beverage stirrer provided by this embodiment, an appropriate amount of drinking water is added into the heating container 310 according to the scale to function as the heat conduction liquid 10; when the cup 100 containing milk is placed in the heating container 310, the heating device 300 and the heat conduction liquid can conduct heat to the cup bottom wall 170 and the cup lower side wall 180 of the cup simultaneously. In related art, the flat aluminum heating plate can only conduct heat to the aluminum plate on the bottom surface of the cup, and the heat conduction area of the bottom surface of the cup is small, so the local temperature of the heating plate rises quickly, and the temperature control device controls the heating plate to perform heating intermittently, resulting in a long heating time. In this embodiment, the circumferential heat conduction area of the cup lower side wall 180 of the cup 100 is added and may be about 1-2 times of the heat conduction area of the cup bottom wall 170 as needed. The heating device 300 continuously heats and conducts heat to the heat conduction liquid 10 and the milk in the cup 100, such that heating and heat conduction are smoother, and the heating and heat conduction area of the lower portion of the cup 100 is enlarged, thus improving the heating efficiency of the milk in the cup 100 and shortening the milk heating time; moreover, it is unnecessary to weld an aluminum heat-conduction plate to the outer bottom surface of the cup 100, such that the complex subsequent machining process of the cup 100 is simplified, the manufacturing cost of the cup 100 is reduced, the product structure is simple, the cup 100 can be cleaned with a dishwasher, production and assembly are facilitated, and the production cost is reduced.

### Embodiment 2

This embodiment is identical in principle with Embodiment 1 and is different from Embodiment 1 in that the cup 100 and the heating container 310 are positioned in a different way.

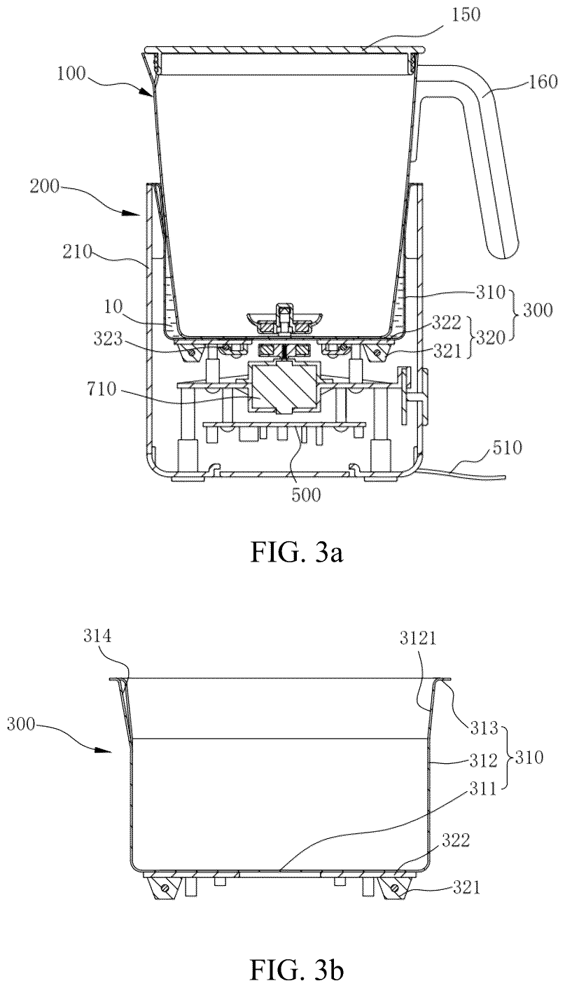

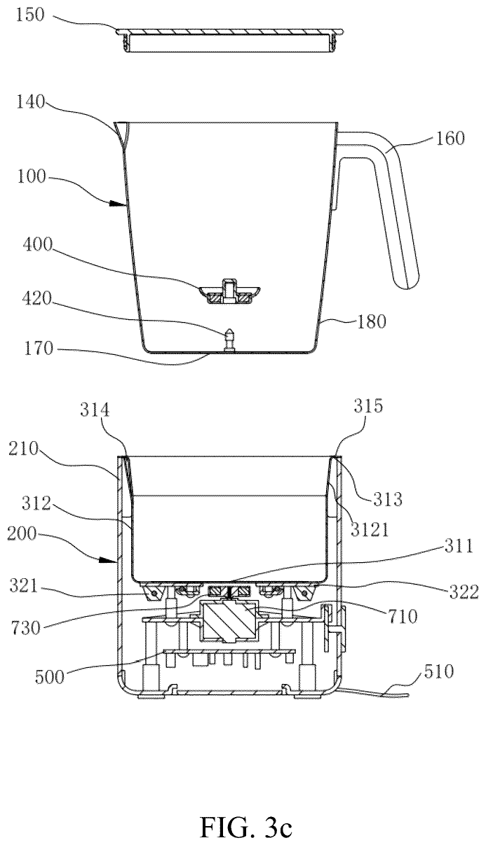

As shown in FIGS. 3a, 3b and 3c, an upper end of the container side wall 312 of the heating container 310 extends and inclines outwards to form a container positioning portion 3121, and the diameter of an upper end of the container positioning portion 3121 is greater than that of a lower end of the container positioning portion 3121; the heating container 310 is provided with a container spout 314 which is configured to discharge hot steam generated when the heat conduction liquid 10 is heated.

The middle area of an outer side wall of the cup 100 correspondingly fits the container positioning portion 3121 to maintain small-clearance movable positioning. When the cup 100 is placed in the heating container 310, the middle area of the outer side wall of the cup 100 fits the container positioning portion 3121 to realizing positioning, the cup bottom wall 170 of the cup 100 is supported on the container bottom wall 311 of the heating container 310, the cup bottom wall 170 of the cup 100 makes contact with the container bottom wall 311 of the heating container 310 to realize heat conduction, and the heat conduction liquid 10 conducts heat to milk in the cup 100 by means of the cup lower side wall 180 of the cup 100. Compared with related art where a heating device only heats the bottom surface of the cup 100, the heat conduction area of the cup lower side wall 180 of the cup 100 is added, such that the heating efficiency of the milk in the cup 100 is higher.

### Embodiment 3

This embodiment is identical in principle with Embodiment 1 and is different from Embodiment 1 in that the cup 100 and the heating container 310 are positioned in a different way.

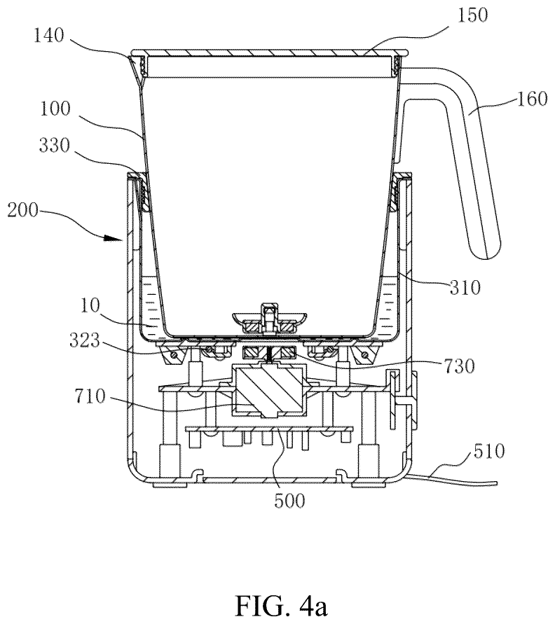

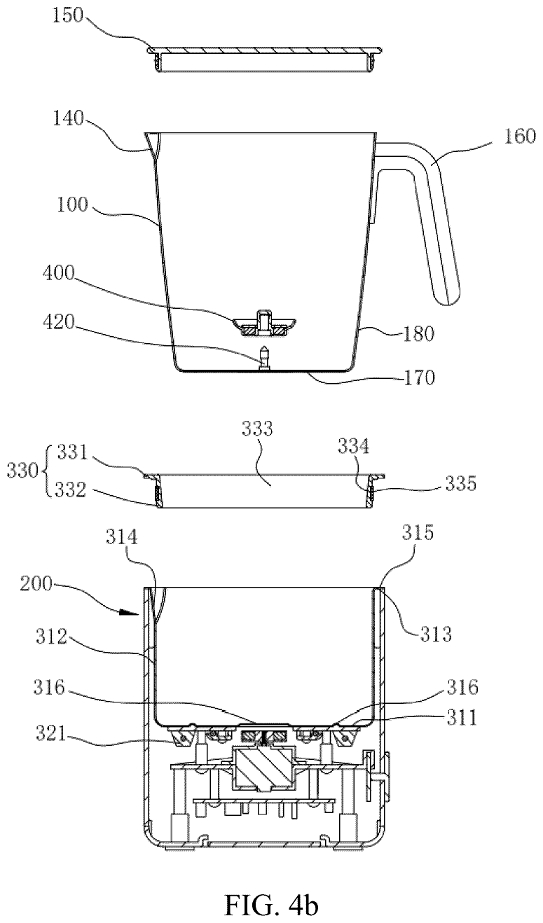

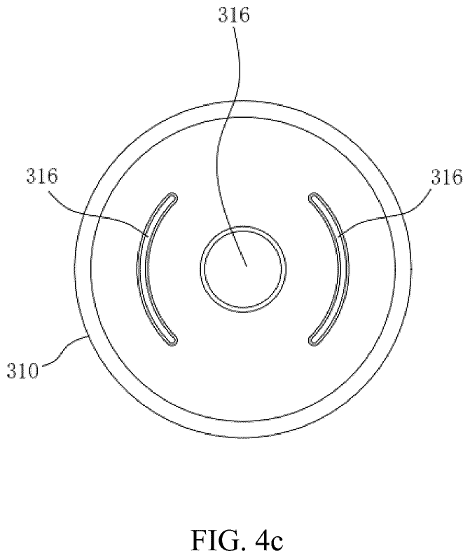

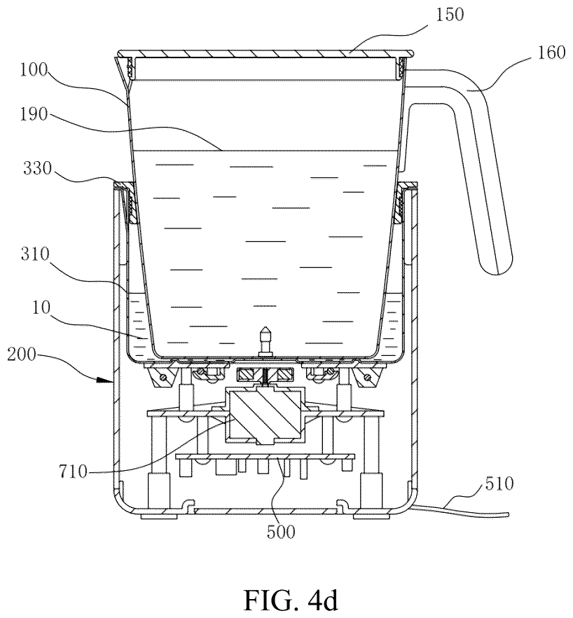

As shown in FIGS. 4a, 4b and 4c, a container lid 330 is detachably arranged at the opening in the upper end of the heating container 310 and comprises a circular upper lid portion 331 and a circular wall 332, a through-hole 333 is defined by the circular upper lid portion 331 and the circular wall 332, the diameter of an upper end of the through-hole is greater than that of a lower end of the through-hole 333, the circular upper lid portion abuts against the container upper end surface 315 of the heating container 310, a circumferential outer side of the circular wall 332 is sleeved with a silicone ring 335, the circular wall 332 is positioned on an inner side wall of the upper end of the heating container 310 by means of the silicone ring 335, and an outer wall of the middle of the cup and an inner wall positioning portion 334 of the through-hole 333 are in small clearance fit to be positioned.

A positioning flange structure 316 is convexly arranged on the container bottom wall 311 of the heating container 310, and the cup bottom wall 170 of the cup 100 is supported on the positioning flange structure 316. By means of the positioning flange structure 316, the cup bottom wall 170 of the cup 100 can be spaced apart from the container bottom wall 311 by a suitable distance to facilitate flowing of the heat conduction liquid and simultaneous heat conduction of the cup bottom wall 170 and the cup lower side wall 180 of the cup 100. The heating container 310 is provided with a container spout 314 which is configured to discharge hot steam generated when the heat conduction liquid 10 is heated.

As shown in FIG. 4d, the milk beverage heating stirrer in this embodiment can function as a kettle. An appropriate amount of the heat conduction liquid 10, which may be drinking water, is added into the heating container 310 according to the scale, the container lid 330 is arranged at the opening in the upper end of the heating container 310, an appropriate amount of drinking water 190 is added into the cup 100 according to the scale, the cup 100 containing the drinking water 190 is then placed in the heating container 310, the cup 100 is covered with the cup lid 150, at this moment, the stirrer 400 is not placed in the cup 100, and then a water boiling function of the switching device 600 is enabled; and when the drinking water in the cup 100 is boiled, the electric control device will power off the milk beverage heating stirrer automatically. In this way, the milk beverage heating stirrer can be used as a kettle conveniently and quickly, and the function of the milk beverage heating stirrer is extended.

What is claimed is:

1. A milk beverage heating stirrer, comprising:
a cup (100), the cup (100) being configured to contain a milk beverage;
a base (200);
a heating device (300), the heating device (300) comprising a heating container (310) and a heating assembly (320), the heating assembly (320) being arranged outside the heating container (310), the heating device (300) being mounted on the base (200), the heating container (310) being formed by a container bottom wall (311), a container side wall (312) and an abutting portion (313), an opening being formed in an upper end of the heating container (310), an upper end of the container side wall (312) extending outwards to form the abutting portion (313), and the abutting portion (313) abutting against an upper end of a shell (210) of the base (200); and
a heat conduction liquid (10), the heat conduction liquid (10) being added into the heating container (310), and the heating device (300) being configured to heat the heat conduction liquid (10);
wherein, the cup (100) is detachably positioned in the heating container (310), the heating device (300) and the heat conduction liquid (10) are configured to heat and conduct heat to a cup bottom wall (170) and a cup lower side wall (180) of the cup (100) simultaneously;
the milk beverage heating stirrer adopts one of the following configurations:
the cup (100) comprises a first receiving portion (110) and a second receiving portion (120) connected with the first receiving portion (110), the first receiving portion (110) is located above the second receiving portion (120), a diameter of the first receiving portion (110) is greater than that of the second receiving portion (120), a support shoulder (130) is formed at a joint of the first receiving portion (110) and the second receiving portion (120), and in a case where the cup (100) is placed in the heating container (310), the support shoulder (130) abuts against a container upper end surface (315) of the heating container (310) and is configured to be movably positioned on the heating container (310);
an upper portion of the container side wall (312) inclines outwards to form a circular container positioning portion (3121), a diameter of an upper end of the container positioning portion (3121) is greater than that of a lower end of the container positioning portion (3121), the cup bottom wall (170) of the cup (100) abuts against the container bottom wall (311) of the heating container (310), and a portion of an outer side wall of the cup (100) abuts against and is positioned on the container positioning portion (3121);
wherein the heating container (310) further comprises a container lid (330), the container lid (330) comprises a circular upper lid portion (331) and a circular wall (332), a through-hole (333) is defined by the circular upper lid portion (331) and the circular wall (332), a diameter of an upper end of the through-hole (333) is greater than that of a lower end of the through-hole (333), the container lid (330) is detachably arranged at the opening of the container (310), the circular upper lid portion (331) abuts against the container upper end surface (315) of the heating container (310), the circular wall (332) is positioned on an inner wall of an upper portion of the heating container (310), and a portion of the outer side wall of the cup (100) is detachably positioned on an inner wall positioning portion (334) of the through-hole (333).

2. The milk beverage heating stirrer according to claim 1, wherein a positioning flange structure (316) is arranged on a bottom inner side of the heating container (310).

3. The milk beverage heating stirrer according to claim 1, wherein a hydrophobic coating material is arranged on an outer surface of the cup (100).

4. The milk beverage heating stirrer according to claim 1, wherein a positioning shaft (420) is fixedly arranged at a center of an inner bottom surface of the cup (100), a stirrer (400) is detachably and rotatably mounted on the positioning shaft (420), and a driven magnet (410) is arranged in the stirrer (400).

5. The milk beverage heating stirrer according to claim 4, wherein a driving device (700) is arranged in the base (200) and comprises a motor (710) and a magnetic driving disk (720) fixedly connected to an output shaft of the motor (710), a driving magnet (730) is fixedly arranged on the magnetic driving disk (720), and the driving device (700) is configured to magnetically drive the stirrer (400) to rotate by means of the magnetic driving disk (720).

6. The milk beverage heating stirrer according to claim 5, further comprising an electric control device (500), a temperature controller (323) and a switching device (600), wherein the heating device (300), the driving device (700), the temperature controller (323) and the switching device (600) are all electrically connected to the electric control device (500), and the electric control device (500) is configured to control the heating device (300) and the driving device (700) to start or stop.

7. The milk beverage heating stirrer according to claim 6, wherein the stirrer (400) is not placed in the cup (100), a preset amount of drinking water (190) is added into the cup (100) according to scale, the cup (100) is covered with a cup lid (150), the heat conduction liquid (10) is added into the heating container (310), and in a case where the cup (100) containing the drinking water (190) is placed in the heating container (310), a water boiling function of the switching device (600) is enabled, and the milk beverage heating stirrer functions as a kettle.
